(19) United States
(12) Patent Application Publication
(10) Pub. No.: US 2005/0188743 A1
(43) Pub. Date: Sep. 1, 2005

(54) Automatic ultrasonic frequency calibration scheme

(75) Inventor: Donald O. Land, Lake Clarke Shores, FL (US)

Correspondence Address: Barry E. Deutsch, Esq.;APPLICA CONSUMER PRODUCTS, INC., Suite 104, 35 Thorpe Avenue, Wallingford, CT, 06492, US

(73) Assignee: H. P. Intellectual Corp.

(21) Appl. No.: 10/787,401

(22) Filed: Feb. 26, 2004

(51) Int. Cl. G01N 29/00; G01V 13/00; G01M 1/14

(52) U.S. Cl. 73/1.82

(57) ABSTRACT

An automatic ultrasonic frequency calibration scheme is provided to automatically calibrate an ultrasonic frequency device to a resonant frequency by using a logic circuit such as a microcontroller to generate a series of distinct digitally synthesized frequencies, measure the power supply current at one or more terminals of a power amplifier at each frequency step generated by the microcontroller, compare the obtained power supply current readings to one another to determine a current reading indicative of a resonant frequency of a ultrasonic transducer, and set the resonant frequency.

### TECHNICAL FIELD

This invention relates generally to ultrasonic calibration and, more specifically, relates to automatic ultrasonic frequency calibration.

### BACKGROUND

U.S. Pat. No. 6,376,444 B1 discloses a garment stain removal product which uses sonic or ultrasonic waves. There is a desire to provide a new type of cleaning device which comprises an automatic frequency calibration system.

The efficiency of an ultrasonic transducer varies with the frequency at which the transducer is excited. It is known that ultrasonic transducers perform optimally at their natural resonant frequency. The natural resonant frequency (or natural frequency) of an ultrasonic sensor transducer changes or “drifts” in response to temperature fluctuations, instrument component aging, mechanical load changes and other similar variables. Ultrasonic transducers vary in impedance and require extremely tight quality control and manufacturing specifications to maintain a resonant frequency within a narrow drift range. Variation in the operating response of an ultrasonic device may lead to inaccurate results unless the device is periodically calibrated by appropriate means. In order to maintain an ultrasonic transducer operating at peak efficiency, the operating or excitation frequency may require adjustments to track the changes in the natural frequency.

Typically, ultrasonic devices are manually tuned by setting a variable inductor or potentiometer after manufacture of the device, usually requiring the use of electronic test equipment, such as, spectrum analyzers, calibrated oscilloscopes, calibrated frequency meters and probes for determining voltage and current. Also, if temperature tracking of drive frequency (to match the transducer resonant frequency) is needed, then the development and implementation of an approximating temperature compensating network is needed. Temperature tracking of the “drifting” natural frequency may include using a temperature sensor co-located with the transducer and a calibration table stored in memory. As temperature change is sensed, the calibration table is accessed to select an updated excitation frequency.

However, such an approach requires the collection and processing of temperature information. Further, the manner and amount of temperature-induced frequency drift may vary from transducer to transducer and separate calibration tables may be required for each transducer. Additionally, the natural frequency may change for other reasons mentioned above, such as component aging and mechanical load changes.

In many applications utilizing power ultrasonic generators, the resonant ultrasonic frequency drifts with time due to self-heating of the subject ultrasonic transducer. A varying mechanical load on the transducer can also cause the resonant frequency to shift. Aging of frequency-determining circuit components can additionally cause the driver to experience a shift in frequency. Also, with many of these devices, the resonant frequency is narrow enough to require precise initial tuning of the driving circuitry. In any of these cases, initial tuning and/or continued re-tuning is required to achieve maximum effective power output from the transducer.

### SUMMARY OF THE PREFERRED EMBODIMENTS

The foregoing and other problems are overcome, and other advantages are realized, in accordance with the presently preferred embodiments of these teachings.

The present invention provides a system and method that includes a logic circuit such as a microcontroller to automatically calibrate an ultrasonic transducer to a resonant frequency.

The invention also provides a software procedure to automatically calibrate an ultrasonic transducer to a resonant frequency by using a microcontroller to generate a range of distinct digitally synthesized frequencies and measure the power supply current at one or more terminals of a power amplifier at each frequency step generated by the microcontroller, compare the obtained power supply current readings, and set the resonant frequency.

This invention eliminates the need to do a frequency calibration at manufacture of the equipment. Additionally, the invention provides for the equipment to recalibrate itself as temperature and mechanical load vary, or as frequency-determining circuit components age.

This invention also maintains drive at the resonant frequency of a transducer for maximum effectiveness.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 is a schematic block diagram of an automatic ultrasonic frequency calibration system suitable for practicing the present invention;

FIG. 2 is a flow diagram according to an embodiment of the automatic ultrasonic frequency calibration system of the present invention; and

FIG. 3 is a perspective view of a cleaning device incorporating features of the present invention.

### DETAILED DESCRIPTION OF THE PREFERRED EMBODIMENTS

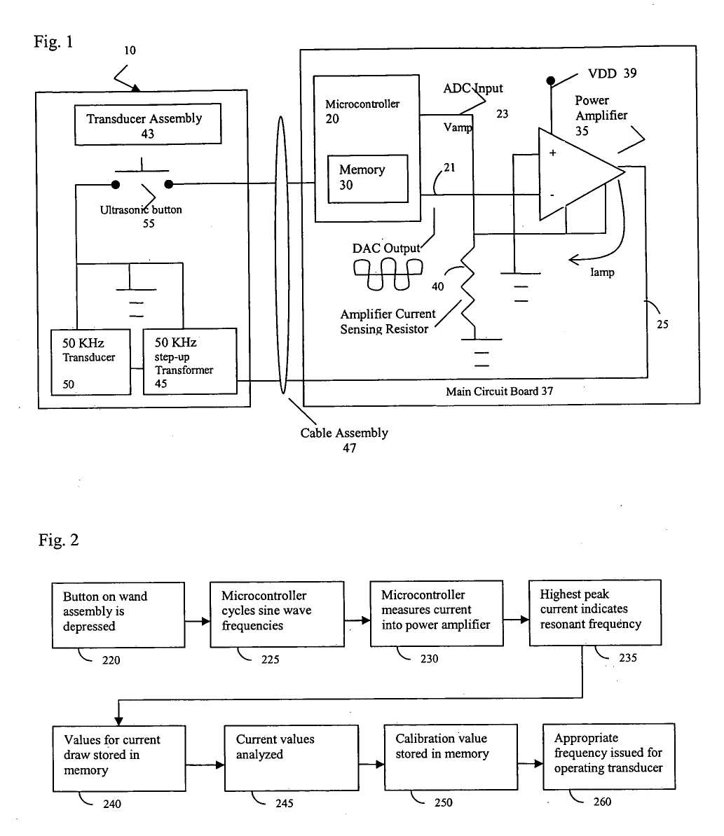

Referring to FIG. 1, a schematic block diagram of an embodiment of the present invention is shown. An automatic ultrasonic frequency calibration system 10 of the present invention includes a controller 20, such as a microprocessor, microcontroller or similar data processing device, that executes program instructions stored in a memory 30, such as a random access memory (RAM), electrically erasable programmable read only memory (EEPROM) or other storage device. The calibration system 10 may form a part of an apparatus such as an ultrasonic cleaning system or any system that uses ultrasonic acoustic energy. The microcontroller 20 converts a digital output on line 21 to an analog sine wave, or a mid-level direct current, that is applied to the input of a power amplifier 35. An analog to digital converter input on line 23 is connected to an amplifier current sensing resistor 40. The output of the power amplifier 35 on line 25 is applied to a step-up transformer 45 and to a ultrasonic transducer 50. Preferably, the step up transformer 45 and ultrasonic transducer 50 are 50 KHz. Preferably, the ultrasonic transducer 50 is a piezoelectric transducer. Capacitors can be used to smooth the low voltage and to provide a fuse to additionally provide protection to the circuit from transient voltages.

The microcontroller 20 steps through a series of digitally synthesized sine wave frequencies within a specified resonant operating frequency range of the ultrasonic transducer 50, including extensions of this range dependant on operating temperature. The automatic ultrasonic frequency calibration system, in accordance with the present invention, can be initiated at start up, or periodically to calibrate the system by depressing an “ultrasonic” button 55. In a preferred, but non-limiting embodiment, a transducer assembly 43 also referred to herein as a wand assembly, is coupled to a main circuit board 37 through a cable assembly 47. In other embodiments, the transducer assembly 43 and main circuit board 37 comprise a single unit. At each frequency step, the power supply current is measured at one or more terminals of the driving power amplifier 35. Synchronized power supply current readings at each discrete frequency are then compared to one another, and to a predetermined minimum value to detect and allow setting to the proper resonant frequency, with the highest current reading being an indication of resonance. A failure to tune to a proper resonant frequency can be indicated by failing to achieve a current reading above a preset threshold, which is predetermined by analyzing performance with the specific type of amplifier and transducer. If a proper resonant frequency is not found, the system may advise an operator of the situation. The system may instead set the device to the best available frequency, or the system may disable the device, depending on the application.

The invention incorporates a software procedure for automatic frequency calibration of the device each time the ultrasonic button 55 is pressed. The calibration procedure resides entirely within the firmware, and it automatically calibrates the device without requiring external equipment, specialized knowledge, or operator interaction. By incorporating this automatic function, no calibration adjustment is needed in the final assembly of a product.

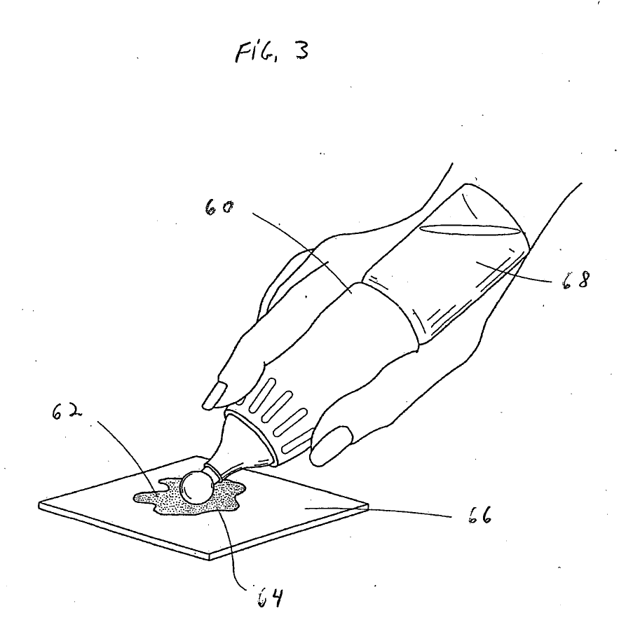

Referring now to FIG. 2, in conjunction with FIG. 1, pressing the ultrasonic button 55 on the wand assembly as indicated by block 220 causes the microcontroller 20 to automatically cycle through distinct operating sine wave frequencies as indicated by block 225 spaced within the operating range. In a preferred embodiment, fourteen distinct operating sine wave frequencies are automatically cycled through a preferred operating range of between 48.5 to 51.5 KHz. Additionally, the inventions' design utilizes direct digital synthesis to generate accurate sine wave frequencies at low distortion. Direct digital synthesis can synthesize directly digital waveforms at the required frequency using a phase accumulator, which accumulates the phase increments. The phase increment input of the direct digital synthesis generates a sinusoid at the desired output frequency. After a short, fixed operating time at each frequency, the microcontroller 20 measures the current into the power amplifier circuit as indicated by block 230, with the highest peak current being an indication of the detected resonant frequency as indicated by block 235 of the ultrasonic transducer 50. The entire procedure requires only a fraction of a second.

Values for the current draw at each frequency step are stored into memory as indicated by block 240.

The fourteen current values are then analyzed as indicated by block 245. They are compared to each other, and to a certain minimum value. The sine wave frequency code for peak current is then automatically stored to the microcontrollers' memory 30 as the calibration value as indicated by block 250. At block 260, the appropriate frequency is issued for the operating transducer. A sine wave table for the device's peak frequency is used for different power levels.

If the calibration is successful, an audible tone will continue as long as the ultrasonic button 55 is held depressed. In the event the calibration is unsuccessful, there will be only a short “beep” to indicate that an error condition has occurred.

Referring now also to FIG. 3, a cleaning device 60 is shown incorporating features of the present invention. The cleaning device 60 is similar to the cleaning device described in U.S. Pat. No. 6,376,444 B1, which is hereby incorporated by reference in its entirety. In this embodiment, the cleaning device 60 is in the form of a hand-held wand with a vibrating, smooth (e.g., spherical) sonic horn or tip at one distal end 62 of the device 60. The stain 64 on an article 66, such as textile, has the cleaning composition applied to it and then is subjected to sonic or ultrasonic waves using the device 60. In this embodiment, the cleaning device 60 comprises a reservoir 68 which holds a liquid cleaning composition. However, in alternate embodiments, the cleaning device 60 might not comprise a liquid reservoir. In addition, features of the present invention can be used in any suitable type of cleaning device which uses ultrasound.

The stain removal product preferably includes instructions for using the product which comprises the steps of: applying an effective amount of the liquid cleaning composition to the stain; imparting sonic or ultrasonic waves to the stain using the sonic or ultrasonic source; and contacting the absorbent stain receiver with the stain while applying pressure so as to absorb the stain into the absorbent material of the absorbent stain receiver. The phrase “effective amount” means an amount of the composition sufficient to saturate the stain, and will typically include applying from about 0.5 ml to about 3 ml of the composition for a small stain (e.g., less than 1 cm in diameter). This amount can vary dramatically if the stained area is very large, for example, on a large area of a garment in which case much more of the composition will be needed to saturate the stained area. It is preferable for the stain to be thoroughly saturated with the cleaning composition such that the soils that have been dislodged by the sonic or ultrasonic waves can be effectively suspended in the composition. In this way, the absorbent stain receiver can absorb all of the soils embodied in the stain via absorption of the cleaning composition.

In another process of using the stain removal product, the stain removal may include instructions for using the product comprising the steps of using the device to apply an effective amount of the liquid cleaning composition to the stain concurrently with sonic or ultrasonic waves from the sonic or ultrasonic source contained in the device; and contacting the absorbent stain receiver with the stain while applying pressure so as to absorb the stain into the absorbent material of the absorbent stain receiver. The pressure is applied by the user's hand in the z direction (i.e., normal to the plane of the fabric being cleaned) and preferably not in the x and/or y directions so as not to cause wear and tear on the material that has been stained. As shown in the FIG. 3, the process is facilitated by using a device 60 such that the composition and the sonic or ultrasonic waves are applied simultaneously to permit controlled dispensing of the liquid cleaning composition to the stain.

Another embodiment of the invention contains the absorbent stain receiver having an absorbent material which is imbibed with a liquid cleaning composition including water, an organic solvent and a surfactant, and a sonic or ultrasonic wave generating source for imparting sonic or ultrasonic waves onto stains on textiles. In this product form, the preferred absorbent material is a Functional Absorbent Material (“FAM”) foam. The process of using this product entails contacting an absorbent stain receiver with the stain, wherein the absorbent material is imbibed with a liquid cleaning composition including water, an organic solvent and a surfactant. The stain receiver can be applied underneath the stained fabric, or alternatively, on top of the stain. Thereafter, pressure is applied by forcing the sonic or ultrasonic device directly against the absorbent stain receiver (in the case of the stain receiver being applied on top of the stained fabric) such that the liquid cleaning composition is forced from the absorbent material into the stain. In the case of the stain receiver being positioned underneath the stain, pressure is applied by pressing the device directly against the stain, which in turn, presses against the stain receiver forcing the cleaning composition into the stain. Sonic or ultrasonic waves from a wave generating source is imparted to the stain, and in both stain receiver positions, the applied pressure is relieved such that the liquid cleaning composition and the stain are absorbed back into the absorbent material in the absorbent stain receiver. This technique allows the cleaning treatment to be localized, thereby minimizing treatment of non-stained areas of the textiles which unnecessarily can increase wear and tear on the stained article.

In a preferred mode of operation, the pressure and sonic or ultrasonic wave application steps are conducted using a pen-shaped, hand-held vibrational sonic or ultrasonic device with a vibrating smooth, rounded (e.g., spherical) sonic horn or tip at one distal end of the device which can be pressed in the z direction against the stain and simultaneously impart the sonic or ultrasonic waves to the stain. The sonic or ultrasonic device can be used directly against the stain with the absorbent stain receiver positioned underneath the stained textile so that the liquid cleaning composition is drawn from the opposition side of the sonic or ultrasonic waves as pressure is applied. Alternatively, the absorbent stain receiver can be contacted with the stain using the sonic or ultrasonic device which is pressed against the stain receiver, which in turn, presses against the stain drawing liquid cleaning composition into the stain. The sonic or ultrasonic waves penetrate through the stain receiver and to the stain, after which the sonic or ultrasonic device is lifted away releasing the pressure such that both the stain and liquid cleaning composition are wicked or absorbed back into the stain receiver.

A variety of sonic or ultrasonic sources can be used in the invention including, but not limited to, sonic cleaning baths typically used to clean jewelry and sonic toothbrushes for cleaning teeth. One suitable sonic or ultrasonic source is a modified sonic toothbrush in which the head of the sonic toothbrush is replaced with a smooth chrome spherical tip as shown in the FIG. 3. Features of the present invention could be used in a toothbrush. Other tip modifications can be made without departing from the scope of the invention so long as the tip structure preferably does not have a structure which can abrade the article with which it comes into contact. Typically, from about 1 watt to about 5 watts, more typically from about 2 watts to about 3 watts, of ultrasonic amplitude is sufficient to treat garments and the like.

The present invention eliminates the need to do a frequency calibration at manufacture of the equipment. The present invention also provides a means for the equipment to recalibrate itself as temperature and mechanical loads vary, or as frequency determining circuit components age. The present invention serves to maintain drive at the resonant frequency of the transducer for maximum effectiveness. The invention can utilize a micro-controller to index through a series of digitally synthesized sine wave frequencies within the specified resonant operating frequency range transducer, including extensions of this range dependant on operating temperature. The power supply current can be measured at one or more terminals on the driving power amplifier. Synchronized power supply current readings at each discrete frequency can then be compared to one another, and to a predetermined minimum value to detect and allow setting to the proper resonant frequency; with the highest current reading being an indication of resonance.

A failure to tune to a proper resonant frequency can be indicated by failing to achieve a current reading above the preset threshold; which is predetermined by analyzing performance with the specific type of amplifier and transducer. If a proper resonant frequency is not found, the unit may advise the operator of the situation, or may set to the best available frequency, or may disable the unit, for example. Another computing device or logic circuit can be substituted for the controller. A stepped analog oscillator can substitute for the digitally synthesized sine wave generator. In many cases, a square wave or other wave form can substitute for the sine wave generator. Direct measurement of current or voltage into the ultrasonic transducer can substitute for measurement of supply current into the power amplifier stage. The number of discrete frequency steps can be altered to provide more or less resolution, depending on the application.

The calibration procedure can be invoked by pressing and holding a calibration switch while pressing and releasing a power button. This can cause the microcontroller to automatically cycle between eleven or more distinct operating sine wave frequencies, such as fourteen for example, within a range, such as 48.5 to 51.5 KHz for example. After a short, fixed operating time at each frequency, the micro controller can measure the relative current into the power amplifier circuit; with the highest peak current being an indication of the detected resonant frequency of the ultrasonic transducer. Relative values of the current at each frequency step can be stored in a nonvolatile flash memory. These values can be viewed with in circuit emulation software, such as Cygnal JTAG for example, if desired for developmental or characterization purposes. The eleven or more relative current values can then be analyzed. They are compared to each other and to a certain minimum value. The sine wave frequency code or peak current can then be automatically stored to the controller's non-volatile flash memory as the calibration value. This value can be read each time the power switch is pressed and the power sine wave table for the peak frequency can be utilized at all power settings including high, medium and low. If a calibration is successful, an audible tone can be generated as long as the buzz button is held depressed. In the event the calibration is unsuccessful, there will be only a short beep.

The entire automated procedure can take less than one second. If the calibration is successful, three power LEDs on the device can be left lighted. In the event of a calibration failure, none of the LEDs will be left lighted. The calibration switch is preferably mounted on top of the board, in a location that essentially eliminates the likelihood of accidental actuation. Re-calibration, other than the automatic calibration described above, should not be necessary over the life of the unit. In an alternate embodiment, if a calibration is successful, an audible tone can be generated as long as the activation button is held depressed. In the event the calibration is unsuccessful, there will be only a short beep. Each time the activation button is pressed, a software procedure can be executed for automatic frequency calibration of the device.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. For example, another computing device or logic circuit can substitute for the microcontroller 20. Also, the microcontroller 20 could be replaced by discrete logic circuits controlled by a solid state machine or similar control device implemented in hardwired or programmable logic, such as an ASIC or an FPGA, respectively. A stepped analog oscillator can substitute for the digitally synthesized sine wave generator. In many cases, a square wave or other waveform can substitute for the sine wave generator. Direct measurement of current or voltage into the transducer can substitute for measurement of supply current into the power amplifier state. The number of discrete frequency steps can be altered to provide more, or less, resolution, depending on the application. As was noted above, the system in accordance with this invention may include an ultrasonic cleaning system or other ultrasonic based system wherein automatic calibration of the acoustic transducer resonant frequency is desirable. However, all such and similar modifications of the teachings of this invention will still fall within the scope of this invention.

1. A method for automatic calibration of an ultrasonic frequency device comprising:
generating a series of waveforms each having a characteristic frequency within a frequency range;
applying said series of waveforms to an amplifier;
for each series of waveforms, measuring a value of current flow of the amplifier;
storing the measured values; and
analyzing the stored values to determine a resonant frequency of the ultrasonic frequency device.

2. A method as in claim 1 wherein generating the series of waveforms comprises generating sine waves.

3. A method as in claim 1 wherein generating the series of waveforms comprises digitally synthesizing the waveforms.

4. A method as in claim 1 wherein the determined resonant frequency is stored for subsequent use.

5. A method as in claim 1 wherein the series of waveforms comprise fourteen waveforms within the frequency range of about 48.5 KHz to about 51.5 KHz.

6. A system for automatic calibration of an ultrasonic frequency device comprising:
a generating device for generating a series of waveforms, each waveform having a characteristic frequency within a frequency range;
an amplifier coupled to an output of said generating device;
an ultrasonic transducer coupled to an output of said amplifier;
a measuring device for measuring a value of current flow of the amplifier at each of said characteristic frequencies;
a storage device for storing the measured values; and
an analysis device for analyzing the stored values to determine a resonant frequency of the ultrasonic transducer.

7. A system as in claim 6 further comprising a memory for storing the determined resonant frequency for subsequent use.

8. A stain cleaning apparatus comprising:
a contact surface for contacting an article to be cleaned; and
a system for automatic calibration of an ultrasonic frequency device as in claim 6, wherein the waveforms can be applied to the article at the contact surface.

9. A system for automatically calibrating an ultrasonic frequency device to operate at a resonant frequency of an ultrasonic transducer comprising:
a microcontroller;
a memory coupled to said microcontroller;
a power amplifier coupled to an output of said microcontroller, said power amplifier having an output coupled to said ultrasonic transducer;
wherein said microcontroller is programmed to generate a series of digitally synthesized waveforms, wherein each waveform comprises a characteristic frequency, wherein said microcontroller is programmed to measure power supply current of the power amplifier at each frequency, and wherein said microcontroller is programmed to compare each frequency to one another and to determine a current reading indicative of a resonant frequency of the ultrasonic transducer.

10. A system as in claim 9 further comprising a transformer coupled to said output of said power amplifier.

11. A system as in claim 9 wherein the ultrasonic transducer comprises a piezoelectric transducer.

12. A system as in claim 9 wherein the ultrasonic transducer is a 50 KHz transducer.

13. A system as in claim 12 wherein the microcontroller while generating the digitally synthesized waveforms, automatically cycles through distinct frequencies spaced within a frequency range of about 48.5 KHz to about 51.5 KHz.

14. A system as in claim 9 wherein the series of digitally synthesized frequencies comprise fourteen distinct frequencies.

15. A system as in claim 9 wherein said system comprises an ultrasonic cleaning system.

16. A stain cleaning ultrasonic frequency device comprising:
a contact surface for contacting an article to be cleaned; and
a system for automatically calibrating the ultrasonic frequency device to operate at a resonant frequency of an ultrasonic transducer as in claim 9, wherein the waveforms can be applied to the article at the contact surface.

17. A software program stored on a computer readable media for directing a microcontroller to execute a procedure for automatic frequency calibration of an ultrasonic transducer of an ultrasonic cleaning system that comprises:
generating a series of waveforms using direct digital synthesis;
measuring a current consumed by an amplifier for each of said series of waveforms;
storing the value of the current of each of said generated waveforms;
analyzing the value of the current of each of said generated waveforms to determine a resonant frequency of the ultrasonic transducer; storing the resonant frequency as a calibration value for subsequent use; and
setting the operating frequency of the ultrasonic transducer to the resonant frequency.
